(19) United States
(12) Patent Application Publication
(10) Pub. No.: US 2008/0076090 A1
(43) Pub. Date: Mar. 27, 2008

(54) METHOD AND APPARATUS FOR GRADUATED ENDODONTIC PLIERS

(76) Inventor: Kristopher Pfotenhauer, Gladstone, MI (US)

Correspondence Address: SCHWEGMAN, LUNDBERG & WOESSNER, P.A., P.O. BOX 2938, MINNEAPOLIS, MN, 55402, US

(21) Appl. No.: 11/534,475

(22) Filed: Sep. 22, 2006

(51) Int. Cl. A61C 3/14

(52) U.S. Cl. 433/159

(57) ABSTRACT

One embodiment of the present subject matter includes a forceps defining a clamping surface, the clamping surface adapted for grasping an absorbent point; and graduations on the forceps defining a distance extending away from a distal tip of the forceps. In various embodiments, the graduations are used for determining a working length of a gutta-percha point.

### TECHNICAL FIELD

This disclosure relates generally to dental tools, and more particularly to method and apparatus for graduated endodontic pliers.

### BACKGROUND

In dentistry, endodontic (root canal) therapy requires a provider to access the canal and file, fill and seal the canal. A cleaning and shaping procedure should remove dental pulp as thoroughly as possible, as well as other unwanted debris found in the canal. Care providers administering endodontic therapy should confine the drilling and cleaning to the target area (canal) and should avoid positioning instrumentation beyond the target area. Further, a filler and sealant should be fitted to a target area, extending into the canal an appropriate amount.

But the target area is often difficult to define. The canals arc away from view, following what is often a blind path into the jaw. Care providers, as such, must use special procedures to define the target area. Currently available procedures determine the canal length, but not without excessive steps. One procedure, commonly called the “paper point” method, enables a practitioner to determine a root canal length using paper points. This method requires a practitioner to insert a paper point into the canal until it absorbs blood (signaling extension past the target area). Care providers measure the length of the paper point which includes blood versus the length which does not. This information reflects the size of the target area.

Care providers often must use multiple paper points. The current method requires comparing the paper point to a ruler. This iterative process increases the time taken to perform a procedure. It additionally requires the use of a ruler to perform measurements. A ruler must be sterilized, and is often cumbersome. If these steps could be avoided, care providers would be able to provide services more quickly, with a reduced risk of complications or failure.

### SUMMARY

The above-mentioned problems and others not expressly discussed herein are addressed by the present subject matter and will be understood by reading and studying this specification.

One embodiment of the present subject matter includes an apparatus, comprising a forceps defining a clamping surface, the clamping surface defining an cylindrical endodontic point recess and graduations on the forceps defining a distance extending away from a distal tip of the forceps along the cylindrical endodontic point recess.

Another embodiment of the present subject matter includes a method for determining the depth of a canal, comprising positioning a first absorbent point into the canal such that a fluid soaked portion is defined, measuring the length of the fluid soaked portion using a graduated forceps, determining a canal working length by subtracting the length of the fluid soaked portion from an overall length of the first absorbent point and positioning a second absorbent paper point in the graduated forceps such that a working portion is exposed, the working portion having an exposed length which is substantially the same as the canal working length.

One embodiment of the present subject matter includes a system, comprising forceps means for determining a canal working length and an absorbent point adapted for disposition in the forceps means such that an exposed portion of the absorbent point extends from the forceps means a distance which is substantially equivalent to the canal working length.

This Summary is an overview of some of the teachings of the present application and not intended to be an exclusive or exhaustive treatment of the present subject matter. Further details about the present subject matter are found in the detailed description and appended claims. Other aspects will be apparent to persons skilled in the art upon reading and understanding the following detailed description and viewing the drawings that form a part thereof, each of which are not to be taken in a limiting sense. The scope of the present invention is defined by the appended claims and their legal equivalents.

### BRIEF DESCRIPTION OF THE DRAWINGS

FIG. 1 is a perspective view of a dental forceps having graduations, according to one embodiment of the present subject matter.

FIG. 2 is a partial side view of a gripper of a dental forceps, according to one embodiment of the present subject matter.

FIG. 3A is a schematic of a dental forceps and a point, according to one embodiment of the present subject matter.

FIG. 3B is a schematic of a dental forceps and a point, according to one embodiment of the present subject matter.

FIG. 3C is a schematic of a dental forceps and a file, according to one embodiment of the present subject matter.

FIG. 3D is a schematic of a dental forceps, a point, and a file, according to one embodiment of the present subject matter.

FIG. 4 is a schematic of a dental forceps, according to one embodiment of the present subject matter.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

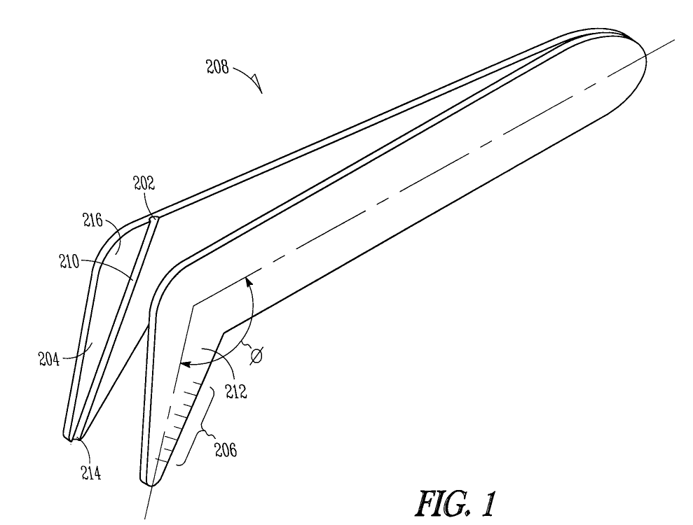

FIG. 1 is a perspective view of a dental forceps having graduations, according to one embodiment of the present subject matter. Various embodiments of the present subject matter include a forceps 208. In various embodiments, the forceps 208 are biocompatible. As such, the present subject matter includes, but is not limited to, stainless steel forceps, titanium forceps, plastic forceps, etc. The forceps pictured include and arc to provide for springiness which separates gripper 212 from gripper 216, but the present subject matter is not so limited, and includes forceps having springs and/or other mechanisms. The forceps 208, in various embodiments, include a clamping surface 204. Clasping surface 204 includes, but it not limited to, contours which are flat, knurled, or otherwise textured.

In various embodiments, the forceps 208 define a recess 210. In some embodiments, the recess 210 runs at least partially through the clamping surface 204 and defines an opening when the clamping surface 204 is pressed against another surface. If the mating surface includes a similar recess, a larger opening is defined. The present subject matter includes, but is not limited to, recesses which are cylindrical. Such recesses provide a semi-circular opening 202, which, when clamping surface 204 is pressed against another surface having a recess which opposes recess 210, defines a circular opening.

In various embodiments, the recess 210 is sized to grasp an endodontic point. The present subject matter is not so limited, however, and includes recesses adapted to grasp other items, such as files, fillers, and/or other items. The present subject matter is not limited to endodontics, and should be interpreted as applicable whenever a forceps is needed to grasp a point.

Various embodiment of the present subject matter include graduations 206 on the forceps. In various embodiments, the graduations are calibrated to inform as to the length of the recess 210. As such, in various embodiments, a care provider can insert a point into recess 210, and quickly determine how far along the recess the point is positioned. In some embodiments, the graduations on the forceps define a distance extending away from a distal tip 214 of the forceps 208 along the recess 210. Graduations may be in metric units, English units, or other units. One embodiment includes graduations in millimeters.

The present subject matter includes the illustrated graduation, which are regular, incremental graduations, but is not limited to such graduations, and could include additional graduations, such as color coded graduations. The illustrated graduations are positioned along a gripper 212 of the forceps 208, but the present subject matter is not so limited. The present subject matter includes graduations positioned along recess 210, in various embodiments.

In various embodiments, the graduations 206 include ink. In some embodiments the graduations 206 include etching. Some of these etchings are compatible with radiography analysis, in various embodiments. Some embodiments include etchings which are laser etched. Some embodiments cast the graduations 206 into the forceps 208 during molding of the forceps 208.

In various embodiments, the graduations are applied to forceps 208 such that they are visible during radiography, including digital radiography. For example, some embodiments include a plastic forceps along which are positioned radioopaque graduations. Various embodiments impregnate a forceps 208 with a radioopaque material. Additional embodiments print a radioopaque material onto the forceps.

Various points are contemplated by the present subject matter including, but not limited to, files, endodontic points, and other points. Endodontic points include, but are not limited to, paper points and/or gutta-percha. Points comprising a sterilization medium are contemplated as well, in some embodiments.

Various embodiments of the present subject matter are packaged in kit form. For example, some embodiments include a kit in which is included a first forceps having first graduations. Various embodiments package a second forceps having a second graduation in the kit. In various embodiments, the kit is useful to provide the care provider with several sterile forceps. Some embodiments, for example, provide the care provider with a first forceps having a cylindrical recess, and a second forceps having a second recess of another shape. In some embodiments, a kit includes a first forceps having a first set of graduations, and a second forceps having a second set of graduations. For example, in some of these embodiments, a first stainless steel forceps is provided having laser etched graduations, with a second plastic forceps having radioopaque graduations impregnated into the forceps. Some embodiments include a kit in which a first forceps having graduations of a first length is packaged with a second forceps having graduations of a second length. The present subject matter includes these kit embodiments, as well as kit embodiments which are not expressly disclosed herein.

FIG. 2 is a partial side view of a gripper of a dental forceps, according to one embodiment of the present subject matter. The illustration shows a recess 204 in which graduations 206 are marked. As such, a point positioned in the recess 204 displays to a care provider the distance from a distal tip 206 a proximal end of a point is positioned. In various embodiments, the graduations are etched into the recess 204. In some embodiment, they are printed in the recess with a resin such as ink. In some embodiments, the graduations provide a contour along the interior of the recess 204 which aid in providing a friction which fixes the location of the point in the recess 204.

Embodiments of the present subject matter additionally contemplate graduation markings which extend at least partially along the recess 204, as well as onto other portions of a forceps. Some embodiments position graduations along a recess and along a clamping surface.

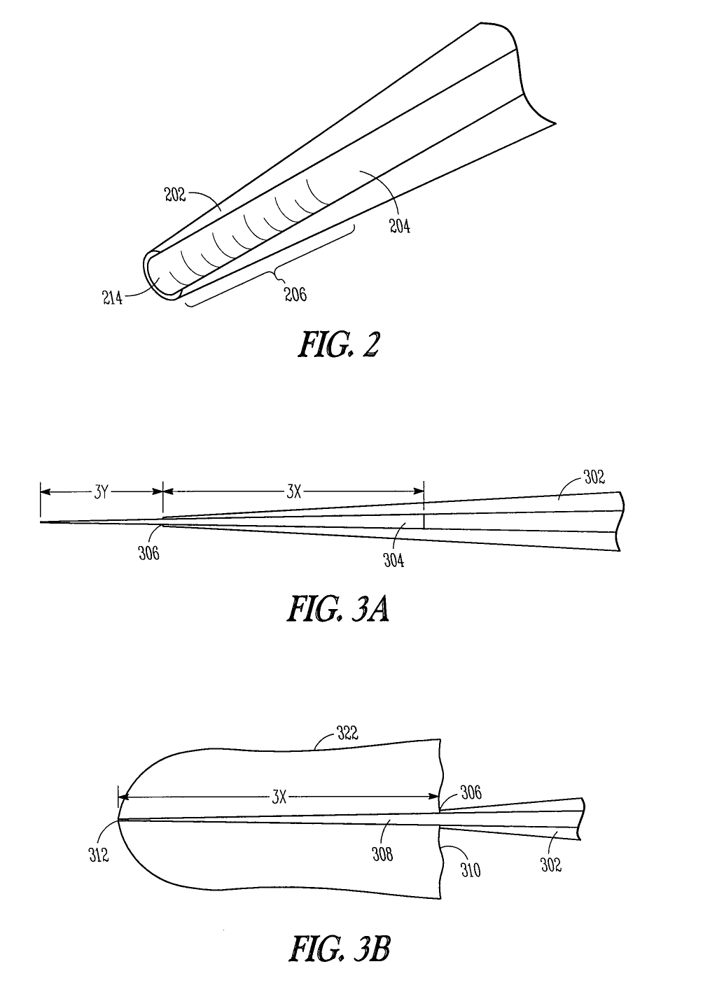

FIGS. 3A-B are schematics of a dental forceps and a point, according to various embodiments of the present subject matter. Various embodiments within the present subject matter include a method for determining the depth of a canal. In various embodiments, a first point 304 is positioned into the canal such that a fluid soaked portion is defined. For illustration purposes, the fluid soaked portion is 3Y in length. In various embodiments, the point 304 is absorbent. In various embodiments, the point 304 is endodontic. In some embodiments, it is paper. In various embodiments, the fluid is blood. Various embodiments include measuring the length of the fluid soaked portion 3Y using a graduated forceps 302. In some embodiments, this is done by repositioning the point as illustrated in FIG. 3A. Various embodiments include determining a canal working length by subtracting the length of the fluid soaked portion 3Y from an overall length (3Y+3X) of the first point 304.

Various embodiments include positioning a second point 308 in the graduated forceps 302 such that a working portion is exposed, as illustrated in FIG. 3B. In various embodiments, this point is an absorbent point. In some embodiments, it is paper. In various embodiments, the working portion has an exposed length 3X which is substantially the same as the canal working length. Some embodiments include inserting the point 308 into the canal such that a distal tip 306 of the graduated forceps abuts a cavosurface 310 which includes an aperture access to a root canal of a tooth 322.

Various embodiments include positioning a gutta-percha point in the graduated forceps such that the distance from a distal portion of the gutta-percha point to a tip 306 of the graduated forceps (3X) is substantially the same as the canal working length. Various embodiments additionally include positioning a gutta-percha point such that the distal portion of the gutta-percha is disposed in a biologically compatible fashion near an apex 312 of the canal. In various embodiments, this includes positioning the point such that the root canal is sealed.

FIG. 3C is a schematic of a dental forceps and a file, according to one embodiment of the present subject matter. Various embodiments of the present subject matter include positioning a file 316 in the graduated forceps 302, substantially parallel to graduations of the graduated forceps. Some embodiments include adjusting a file stopper 318 such that the distance from the distal tip of the file to the file stopper is substantially the same as the canal working length (3X). Some of these embodiments include filing the canal with the file such that the file stopper limits the distance the file extends into the canal by abutting an access aperture of the canal.

Some embodiments include rinsing the canal with a rinse. These embodiments include, but are not limited to, sodium hypochlorite, water, saline, sodium hypochlorite, sodium hypochlorite, local anesthetic, chlorhexidine gluconate, calcium hydroxide paste, and/or other materials. Various embodiments include drying the canal with the second absorbent paper point by inserting the second absorbent paper point in the canal such that the tip of the graduated forceps abuts the access aperture of the canal.

FIG. 3D is a schematic of a dental forceps, a point, and a file, according to one embodiment of the present subject matter. Various embodiments adjust the rubber stopper 318 by positioning a file next to the second point 308, while the second point 308 is in the forceps 302. When the file is positioned next to the second point 308 in a substantially parallel manner such that a distal tip 320 of the file 316 is next to a tip 306 of the graduated forceps 302, a working length for the file is determined, in various embodiments. With the stopper 318 adjusted as such, the file is suited for working only along the working length of the canal.

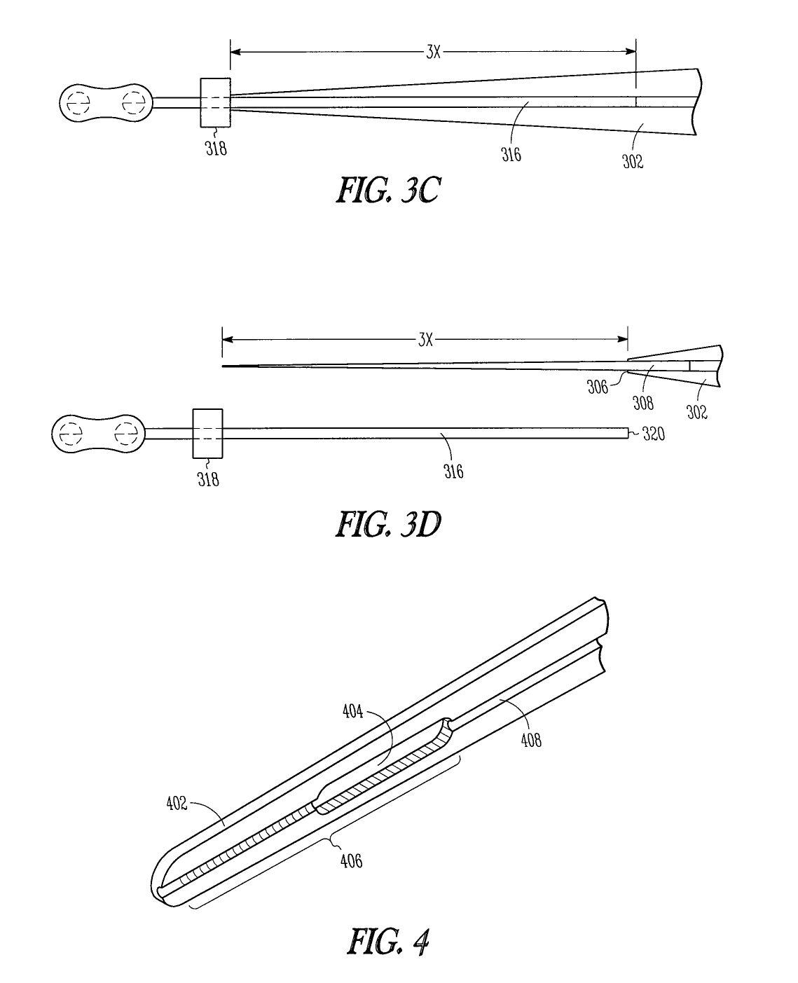

FIG. 4 is a schematic of a dental forceps 402, according to one embodiment of the present subject matter. Some embodiments of the present subject matter include graduations 406 which are positioned in a window 404 along the recess 408. The graduations 406, in various embodiments could be inside the window 404 (positioned along a recess), positioned along the frame of the window 404, or positioned outside the window 404 alongside the window. The window 404, in various embodiments, is an aperture. Some embodiments include a window which includes a translucent or transparent substance. This is not an exclusive or exhaustive exclusive list of window configurations, as other window configurations fall within the present scope.

Although specific embodiments have been illustrated and described herein, it will be appreciated by those of ordinary skill in the art that any arrangement which is calculated to achieve the same purpose may be substituted for the specific embodiment shown. This application is intended to cover adaptations or variations of the present subject matter. It is to be understood that the above description is intended to be illustrative, and not restrictive. Combinations of the above embodiments, and other embodiments will be apparent to those of skill in the art upon reviewing the above description. The scope of the present subject matter should be determined with reference to the appended claims, along with the full scope of equivalents to which such claims are entitled.

We claim:

1. An apparatus, comprising:
a forceps defining a clamping surface, the clamping surface defining a cylindrical endodontic point recess; and
graduations on the forceps defining a distance extending away from a distal tip of the forceps along the cylindrical endodontic point recess.

2. The apparatus of claim 1, wherein the endodontic point is a paper point.

3. The apparatus of claim 1, wherein the endodontic point is a gutta-percha point.

4. The apparatus of claim 1, wherein the forceps is a first forceps having first graduations, and is part of a kit including at least a second forceps having a second graduations.

5. The apparatus of claim 4, wherein the first graduations are of a different length than the second graduations.

6. The apparatus of claim 1, wherein the graduations is disposed on the forceps along the clamping surface.

7. The apparatus of claim 6, wherein the graduations are laser etched into the forceps.

8. The apparatus of claim 1, wherein the graduations are disposed on the forceps on a surface which does not include the clamping surface.

9. The apparatus of claim 8, wherein the graduations include ink.

10. A method for determining the depth of a canal, comprising:
positioning a first absorbent point into the canal such that a fluid soaked portion is defined;
measuring the length of the fluid soaked portion using a graduated forceps;
determining a canal working length by subtracting the length of the fluid soaked portion from an overall length of the first absorbent point; and
positioning a second absorbent paper point in the graduated forceps such that a working portion is exposed, the working portion having an exposed length which is substantially the same as the canal working length.

11. The method of claim 10, further comprising:
positioning a gutta-percha point in the graduated forceps such that the distance from a distal portion of the gutta-percha point to a tip of the graduated forceps is substantially the same as the canal working length.

12. The method of claim 11, further comprising inserting the gutta-percha point in the canal such that the tip of the graduated forceps abuts an access aperture of the canal.

13. The method of claim 12, wherein the distal portion of the gutta-percha is disposed a biologically compatible near an apex of the canal.

14. The method of claim 10, further comprising:
positioning a file next to the graduated forceps substantially parallel to graduations of the graduated forceps;
adjusting a file stopper such that the distance from the distal tip of the file to the file stopper is substantially the same as the canal working length.

15. The method of claim 14, further comprising filing the canal with the file such that the file stopper limits the distance the file extends into the canal by abutting an access aperture of the canal.

16. The method of claim 15, further comprising rinsing the canal with a rinse.

17. The method of claim 16, wherein the rinse includes sodium hypochlorite.

18. The method of claim 16, further comprising drying the canal with the second absorbent paper point by inserting the second absorbent paper point in the canal such that the tip of the graduated forceps abuts the access aperture of the canal.

19. A system, comprising:
forceps means for determining a canal working length; and
an absorbent point adapted for disposition in the forceps means such that an exposed portion of the absorbent point extends from the forceps means a distance which is substantially equivalent to the canal working length.

20. The system of claim 19, wherein the forceps means include a forceps defining a clamping surface, the clamping surface adapted for grasping an absorbent point; and graduations on the forceps defining a distance extending away from a distal tip of the forceps.
